(19) United States
(12) Patent Application Publication
(10) Pub. No.: US 2014/0119699 A1
(43) Pub. Date: May 1, 2014

(54) OPTICAL FIBER CABLE HAVING SPLINE PROFILED INSULATION

(71) Applicant: NEXANS, Paris (FR)

(72) Inventors: David Keller, Cary, NC (US); Randie Yoder, Garner, NC (US); Chris Raynor, Holly Springs, NC (US); Terry Gooch, Holly Springs, NC (US); Greg Heffner, Epharta, PA (US); Joshua Keller, Mechanicsburg, PA (US); Mike Good, Lancaster, PA (US)

(73) Assignee: NEXANS, Paris (FR)

(21) Appl. No.: 13/660,227

(22) Filed: Oct. 25, 2012

(51) Int. Cl. G02B 6/44

(52) U.S. Cl. CPC G02B 6/4401
USPC 385/102; 385/109

(57) ABSTRACT

An optical fiber cable includes at least one optical fiber element and a tight buffer coating on the optical fiber element, where the tight buffer coating on the optical fiber element includes a plurality of alternating splines and grooves facing outwardly towards the outer circumference of the tight buffer coating. Additionally, an optical fiber cable can have at least one optical fiber element and at least one buffer tube surrounding the optical fiber element, where the buffer tube around the optical fiber element includes a plurality of alternating splines and grooves facing outwardly towards the outer circumference of the buffer tube.

### BACKGROUND

1. Field of the Invention

This application relates to communication cables. More particularly, this application relates to fiber optic cable insulation.

2. Description of Related Art

Fiber optic cables, such as loose tube fiber optic cables, are generally constructed with an outer jacket, one or more buffer tubes therein and one or more fibers contained within each buffer tube. Tight Buffer optical fibers on the other hand have a closely extruded jacket directly on the fiber for a more rugged construction. With both loose tube and tight buffer optical fibers, the tubes or tight buffer jackets are made from extruded polymer.

Among all of the various construction issues that go into forming either the loose buffer tubes or the tight buffer jackets, including polymer selection, tube/tight buffer jacket sizing, extrusion controls etc. . . . , one additional issue that arises during production is the need to completely dry the extruded cable after it's passed through the water cooling bath and prior to optical inspection. During the production of the loose buffer tubes and tight buffer/jackets, a fiber or fibers are pulled through an extrusion head with the molten polymer flowing thereon. As the molten polymer exits the die it quickly cools to a solid, forming the tube or buffer/jacket. To completely cool the polymer, typically a water bath is employed just after the tubes and buffer/jackets exit the die so that the polymer does not stick to itself on the take up reels at the end of the extrusion line. The water is usually blown off with an air stream prior to the cable being taken up on the take up reels.

Separately, laser (or LED) light source and sensor variation are employed to inspect extruded lines for lumps and other surface irregularities and to detect whether or not the extrusion process is proceeding normally. As can be expected, the combination of laser inspection for lumps, combined with the water cooling process can occasionally lead to problems. For example, water droplets remaining on the extruded cables from the extrusion cooling stage may cause false lump positives in the testing phase, which ultimately can lead to slower production times.

Another issue that can occur during jacket production, is that after extruding the loose buffer tubes or tight buffer jackets, and when later extruding or applying the outer protective cable jacket, the tight buffered fibers or loose buffer tubes need to be pulled through a second outer jacket extrusion phase under a given back tension to prevent processing errors caused by the cooling and the shrinking of jacket polymer.

For example, in the case of applying an external jacket over one or more tight buffered optical fibers the coefficient of friction of the tight buffered fiber is a relevant processing factor as it is fed into this second extrusion process. The tight buffered fiber(s) are first surrounded by aramid or fiberglass yarns and then encapsulated by the jacket plastic.

Back tension is applied to the tight buffer being jacketed to shift the (relative) downstream process speed with respect to the yarns and plastic based on the coefficient of friction of the tight buffered fiber, and other physical characteristics of the yarns and jacket polymer. This back tension applied to the tight buffer postpones the “coupling point” or point where the tight buffer is proceeding linearly at the same speed as the yarns and cooling jacket plastic. The goal with such a back tension is to postpone this coupling point (i.e. increasing the distance from jacket extrusion until it draws down and contacts the tight buffer fiber) until after as much plastic shrinkage has already occurred as possible (in the jacket polymer) so that the length of the fiber ultimately remains equal to the length of the cable rather than it ending up coiled within as a result of a mis-match in the polymer application of the jacket on the tight buffer.

In this respect, the tension required for this back tension operation is a function of the normal force or tightness of the yarns on the tight buffer, the coefficient of friction and surface area of the tight buffer and the length downstream in the jacketing process that one wants to impact. In current prior art arrangements, the coefficient of friction of the tight buffer fiber is limited based mostly on the composition of the tight buffer polymer thus limiting how far downstream one could place the coupling point. Moreover, in the area of loose tube cable constructions, a related drawback can occur when the fibers stick to the molten plastic of the tubes just exiting the extruder or tube wall, which has a similar negative effect as when the subunits, the aramid(s) or tight buffered fibers stick to the molten subunit wall. In both cases, by reducing the contact surface area, less sticking or bonding takes place.

Furthermore, generally with all tight buffer and loose tube cables, it is usually ideal to remove as much polymer material as possible while retaining maximum protection in order to improve overall production costs while reducing weight

### OBJECTS AND SUMMARY

The present arrangement overcomes the drawbacks associated with the prior art and provides for profiled or shaped insulation, including reduced outer surface area, in order to improve water removal during cooling, reduction in coefficient of friction for subsequent cable jacketing and reduction in material usage. The present arrangement may be used on tight buffer, buffer tubes and/or jackets.

One object of the present arrangement is to provide for production line improvements in the production of tight buffer and loose tube optical fiber cables.

Another object is to reduce the cost and material in the production of tight buffer and loose tube optical fiber cables. In this context, the present arrangement further reduces the fuel component of flame retardant cables by reducing the amount of flammable material.

Another object of the present arrangement is to improve the compression resistance of loose tube and tight buffer designs by creating splines of compression resistance, while not transmitting compression forces toward fiber interior. Grooves or fins which are located around the periphery of the insulation also provide a reduction of surface contact with multiple surrounding components. This decreases attenuation caused by pressure applied to the fiber by the polymer. Further the grooves prevent the direct interior glass deflection usually rendered by harmful exterior compression forces, by allowing the splines to flex under the compression loads.

Another object of the present arrangement is to reduce the coefficient of friction of loose tube and tight buffer fiber cable designs by creating physical breaks in (drag) contact surface area using grooves. This allows one to reduce the coefficient of friction, so that when an external jacket is being applies, the process temperature contraction lock-in point can be pushed further downstream from the extrusion point, reducing processing mismatches between the jacket and the tube/buffer polymers so as to remove forces that can cause bending of the fibers (thus reducing attenuation).

In this context, the grooves or slotted surface of the tight buffer can be used to promote a detached or sliding tight buffer element which postpones the coupling point further downstream in the jacketing process. This reduces the need for as much back tension on the tight buffer, thus reducing its loading compared to the aramid when exposed to in the cable installation tensile loads. Unlike the prior art where the fibers (or tubes/buffers) can stick to the molten plastic just exiting the extruder or tube wall (loose tube), with subunits, aramid(s) or tight buffer(s) stick to the subunit wall, the present arrangement reduces the contact surface area of the tubes and/or buffer insulation resulting in less sticking or bonding between the cable components during production.

Another object of the present arrangement is to reduce water droplet/false lump pickup during processing by changing tight buffer surface to water dynamic thereby allowing water to be consistently blown off.

Another object of the present arrangement is to reduce friction of connector insertion while maintaining the critical diameter needed for terminating in connectors. Additionally, the connector process is made easier if the optical fiber (glass and uv coating) is centered within the tight buffer, and the tooling having a grooved die provides the added beneficial aspect of aiding in the centering of the optical fiber within the tight buffer. Further the tight buffer element, having grooved insulation, is more easily slid into the connector housing which is placed typically at the end of each tight buffer fiber length.

Overall, the active assembly of an optical fiber cable is a balancing of tensions, frictions, wrapping normal forces and plastic applications and shrinkage parameters. Grooves on the inner and outer surfaces of the tubes or tight buffers, as proposed in more detail below, are a solution to further manage the contact or frictional-adhesive relationships between the jacket and tube/buffers in this assembly process.

To this end, the present arrangement includes An optical fiber cable includes at least one optical fiber element and a tight buffer coating on the optical fiber element, where the tight buffer coating on the optical fiber element includes a plurality of alternating splines and grooves facing outwardly towards the outer circumference of the tight buffer coating.

Additionally, an optical fiber cable can have at least one optical fiber element and at least one buffer tube surrounding the optical fiber element, where the buffer tube around the optical fiber element includes a plurality of alternating splines and grooves facing outwardly towards the outer circumference of the buffer tube.

### BRIEF DESCRIPTION OF THE DRAWINGS

The present invention can be best understood through the following description and accompanying drawings, wherein:

FIG. 1 is a perspective cut-away view of a tight buffer fiber and insulation according to one embodiment;

FIG. 2 is a perspective cut-away view of a tight buffer fiber and insulation according to one embodiment;

FIGS. 3a-3d are front cut away views of a tight buffer fiber and insulation according to one embodiment;

FIG. 4 is a front cut away view of a tight buffer fiber and insulation with dimensions according to one embodiment;

FIG. 5 is a graph showing a percentage of polymer reduction according to the measurements in Table 1, in accordance with one embodiment;

FIG. 6 is a graph showing a percentage of polymer reduction according to the measurements in Table 2, in accordance with one embodiment;

FIGS. 7a-7c are perspective cut-away views of a tight buffer fiber and insulation in a jacket in accordance with one embodiment;

FIG. 8 is a perspective cut-away view of a loose tube fiber and insulation in accordance with one embodiment;

FIG. 9 is a perspective cut-away view of a loose tube fiber and insulation in accordance with another embodiment;

FIGS. 10a-10b illustrate a die for producing the fiber insulation in a tubing process in accordance with one embodiment; and

FIGS. 11a and 11b illustrate a die for producing the fiber insulation in a pressure process in accordance with one embodiment.

### DETAILED DESCRIPTION

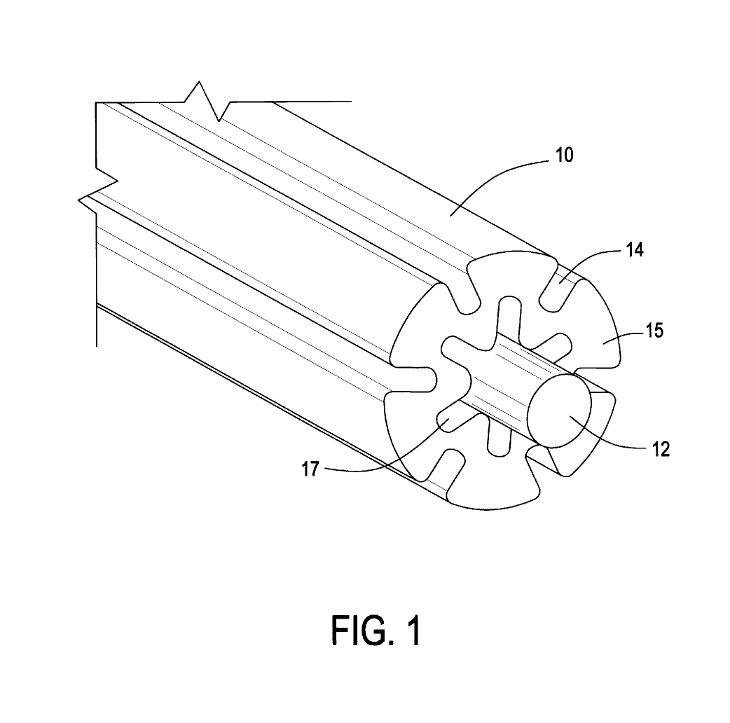

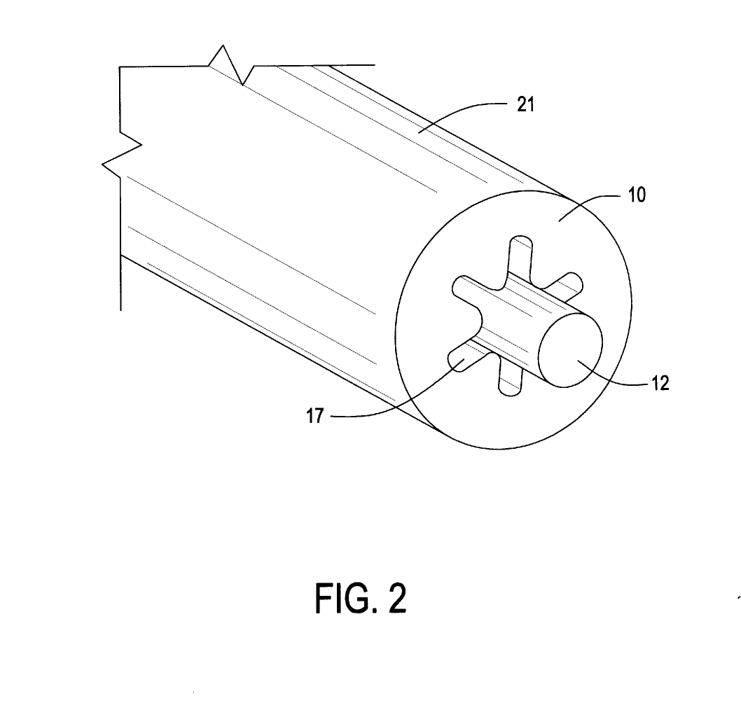

In one embodiment as shown in FIG. 1, a first tight buffer fiber is shown having buffer 10 surrounding a fiber 12. Buffer 10 maintains a plurality of outer grooves 14 located around the outer periphery of buffer 10, dividing buffer 10 into corresponding lobes 15. Additionally, buffer 10 maintains a plurality of inner grooves 17 facing inward towards fiber 12. FIG. 2 shows an alternative embodiment with fiber 12 and buffer 10, but only having inner grooves 17 with a smooth outer surface 21.

It is noted that certain applications for tight buffered fibers require staged stripping where tight buffer insulation 10 is stripped off of fiber 12 for a length of several inches leaving the optical fiber 12 with the fiber's typical UV coating intact. Thereafter the UV coating is striped off for an additional separate length for connectorization purposes. The inner grooves 17 allow for easier and more consistent stripping off of the tight buffer layer 10 while leaving the UV coating of fiber 12 intact.

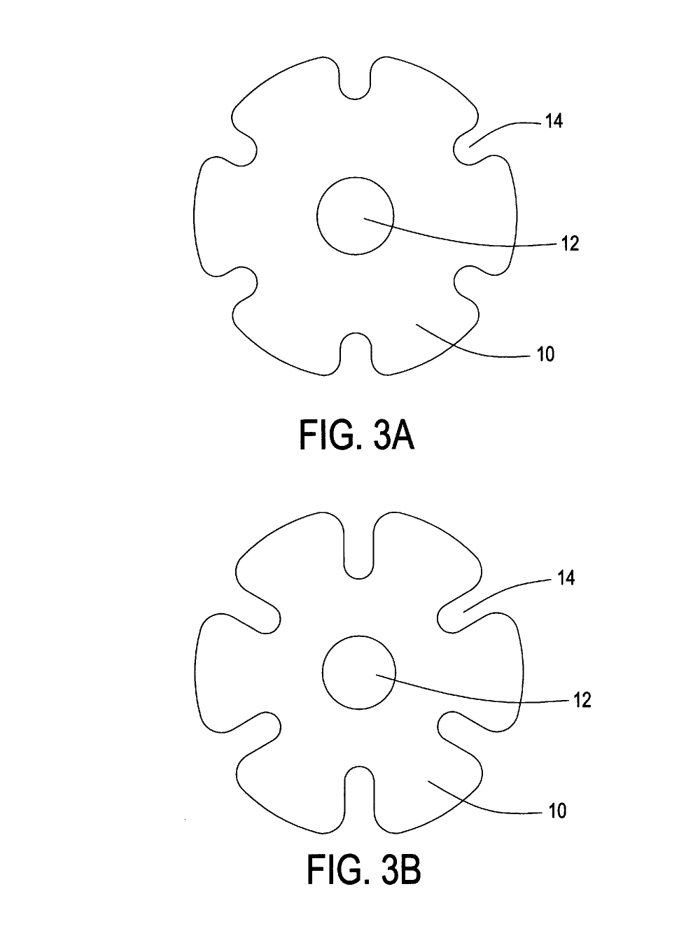

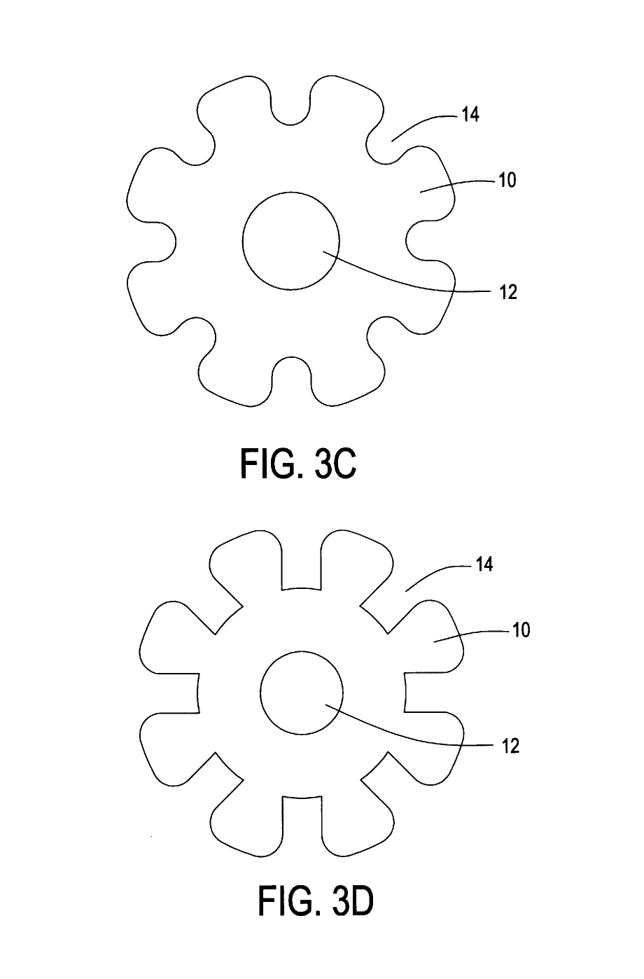

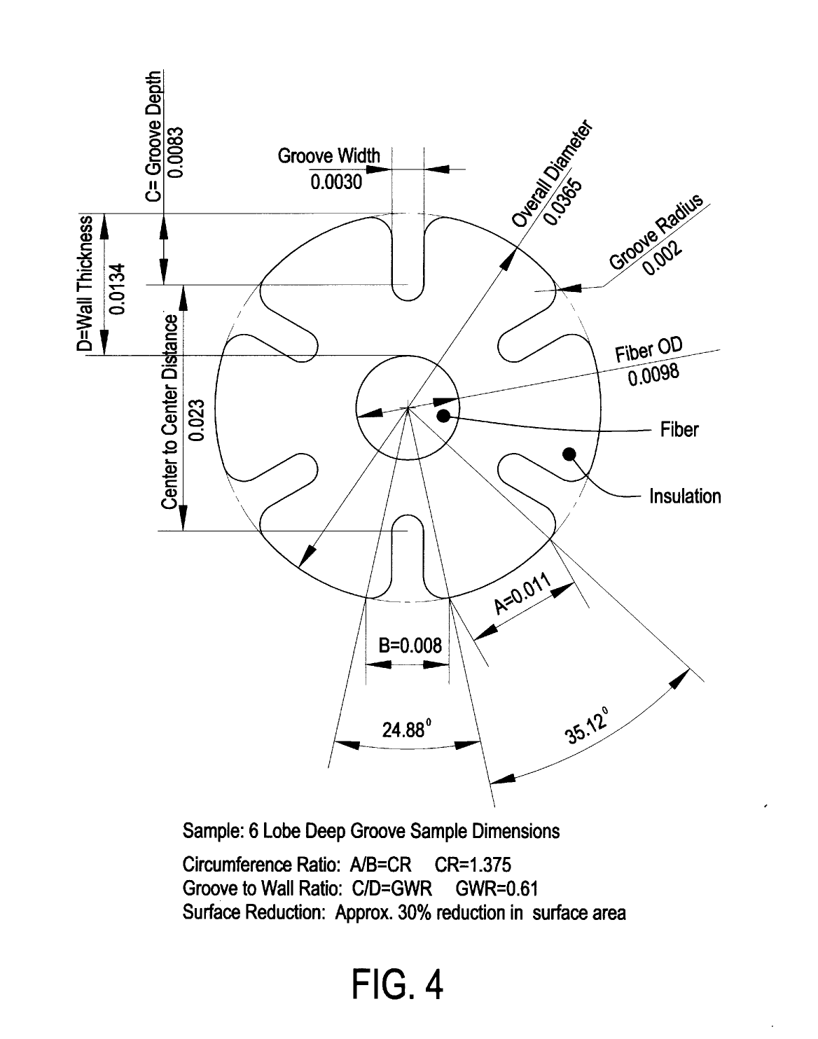

It is noted that in many stripping situations the UV coating tends to pull off the glass fiber 12 at that the same time the buffer 10 is stripped. In such cases an alternative design with only outer grooves 14 may be used, where buffer 10 has a tighter adhesion or firmer grip against fiber 12. FIGS. 3a-3d show four different exemplary buffers 12 using six (6) or eight (8) shallow or deep outer grooves 14 with no inner grooves. FIG. 4 shows an exemplary buffer 12 with six (6) deep grooves 14 and a set of exemplary sizes/dimensions.

The following table 1 gives exemplary weight reductions based on a standard 900 micron thickness tight buffer fiber insulation 12.

TABLE 1

| | Avg. Weight | % Reduction in insulation |
|---|---|---|
| | gms/3′ | weight from standard |
| Standard | 0.9118 | |
| Insulation | | |
| 6 Lobe Shallow | 0.8036 | 11.87% |
| 6 Lobe Deep | 0.7755 | 14.95% |
| 8 Lobe Shallow | 0.745 | 18.29% |
| 10 Lobe | 0.7229 | 20.72% |
| Shallow | | |

With these grooves, both outer grooves 14 and inner grooves 17, using different sizes and depths, a reduction of approximately 10-25% in tight buffer 12 material relative to a standard 900 micron tight buffer fiber can be achieved.

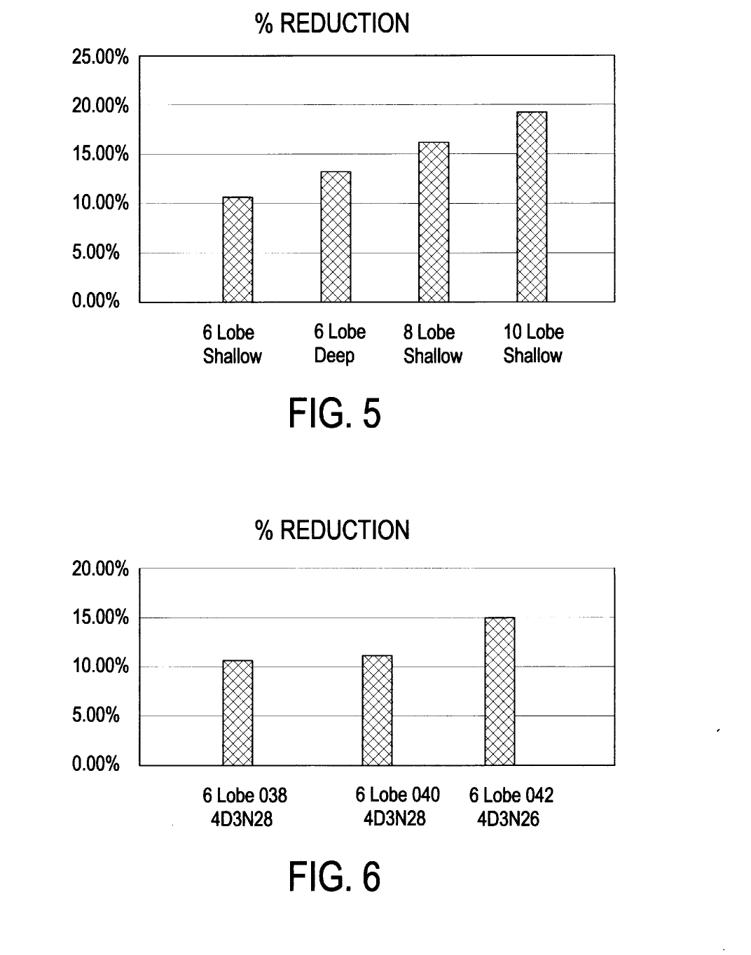

In one arrangement exemplary dimensions for outer grooves 14 on a tight buffer fiber may be as follows:
0.0354″ (900 microns) nominal diameter;
groove heights between 0.003″ and 0.008″ (could range from 0.001″ to 0.025″) depending on the quantity of grooves, diameter, and insulation wall thickness;
groove width(s) between 0.003″ and 0.006″ (could range from 0.001″ and 0.025″) depending on the quantity of grooves, diameter, and insulation wall thickness; and
quantity of grooves varies between 6 and 10 (could range between 2 and 25) depending on the diameter and insulation wall thickness.
   (The exemplary inner grooves 17 may be formed with substantially the same dimensions as outer grooves 14). The following bar chart shows additional exemplary reductions in insulation material for tight buffer fibers using the exemplary width and height dimensions for outer grooves 14. The attached FIG. 5 is a graph showing the percentage reductions of Table 1 above.

The following table 3 includes another set of exemplary data for six lobe/groove 14 tight buffer designs, with different groove 14 dimensions and the corresponding reduction in insulation/material. The attached FIG. 6 is a graph showing the percentage reductions of Table 2 below.

TABLE 2

| | Avg. | | | | |
|---|---|---|---|---|---|
| | Weight | | Insulation | Groove | Grove |
| | gms/3′ | % Reduction | diameter | Height | Width |
| Standard | 0.9118 | | | | |
| Insulation | | | | | |
| 6 Lobe 038 | 0.79015 | 13.34% | 0.0351 | 0.0042 | 0.0050 |
| (#4D3N28) | | | | | |
| 6 Lobe 040 | 0.7894 | 13.42% | 0.0354 | 0.0053 | 0.0040 |
| (#4D3N28) | | | | | |
| 6 Lobe 042 | 0.7576 | 16.91% | 0.0356 | 0.0073 | 0.0066 |
| (#4D3N26) | | | | | |

Applicants note that deeper grooves may be used to provide more material savings and more flexibility, and possibly lower crush resistance. Shallower grooves may be used to provide a stiffer product and less material reduction, but possibly more crush resistance. It is likewise noted that more material reduction can be achieved with more grooves but the product may have lesser crush resistance and consistent extrusion results when such considerations are less important. More grooves allow high reductions, greater flexibility. A higher number of grooves also decrease the nesting ability of adjacent fibers/cables, because grooves can be made narrower while retaining the same reduction in material.

Generally speaking the exemplary embodiment uses six (6) grooves 14 where buffer 12 has an OD of 0.0365″ with grooves 14 approximately 0.0065″ deep and 0.003″ wide. However, using different amounts and sizes for outer grooves 14, it is possible to remove 10-25% of material, with outer groove 14 depths substantially in the range of 25-65% of wall thickness and groove 14 width substantially in the range of 5-15% of overall buffer 12 diameters.

Such arrangements, in addition to the apparent reduction in material use, also improve compression resistance (reduced attenuation under compression). It is noted that, in fact, lobes 15 on either side of outer grooves 14 actually compress more easily than a solid buffer insulation. However, deflection of lobes 15 improves attenuation results by absorbing energy in a different manner such as by not transmitting to the interior surface of buffer 10 (against fiber 12). In other words, lobes 15 under compression deflect side to side as well as downward towards fiber 12 thus deflecting compression stress away from fiber 12.

Another advantage of the present arrangement as shown in FIGS. 1-4 is the improvement in the water inspection step during the process of applying buffer 10. Typically, a lump detection device is a device that measures light source energy fluctuations to sensors from side to side and top to bottom of a fiber 12/buffer 10 on the production/extrusion line as explained before. Water baths are used to cool the buffer 10 as it is applied to fiber 10, but the surface energy or surface tension of water allows it to resist the external force of the air wipe or air flow devices intended to remove it. Even a very small drop of water is registered by the lump detector, requiring costly re-spooling and re-inspection at slower speeds. Outward grooves 14 reduce the surface area and thus reduce water surface tensions allowing the air flow to remove the water above and within the grooves to avoid false lump readings.

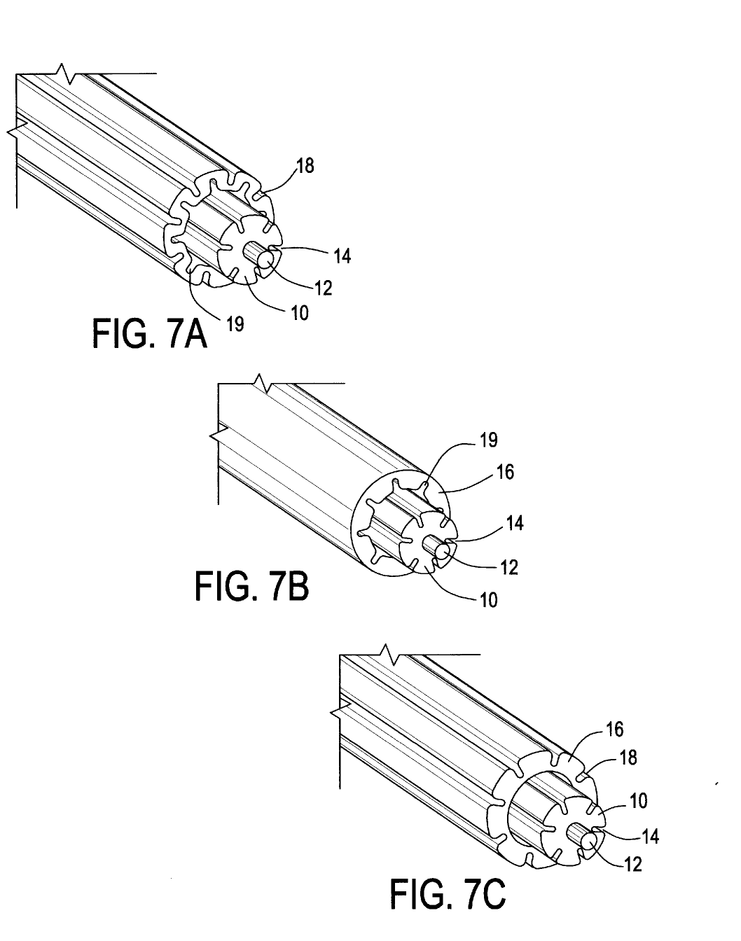

In another embodiment shown in FIGS. 7a-7c, tight buffer fiber 12 is further encased in a jacket. In the examples, the arrangement for buffer 12 includes only outward facing grooves 14, however it is understood this is for exemplary purposes and buffer 12 with inner grooves 17 or both inner and outer grooves 14 and 17 may be used in conjunction with the following described jacket.

In FIG. 7a fiber 12 is surrounded by a first grooved buffer 10, similar to that shown in FIG. 1, but with outward grooves 14. Buffer 10 rests directly against the entire fiber 12. Surrounding buffer 10 is an additional profiled jacket 16 with both outward grooves 18 facing the outer circumference of jacket 16 and inward grooves 19 facing in towards buffer 10. FIGS. 5b and 5c show the same embodiment except in FIG. 7b, jacket 16 only has inner grooves 19 and in FIG. 7c, jacket 16 only has outer grooves 18. Jacket 16 provides an additional layer of protection with grooves 18/19 providing similar advantages to that described above in conjunction with grooves 14/17 in buffer insulation 10.

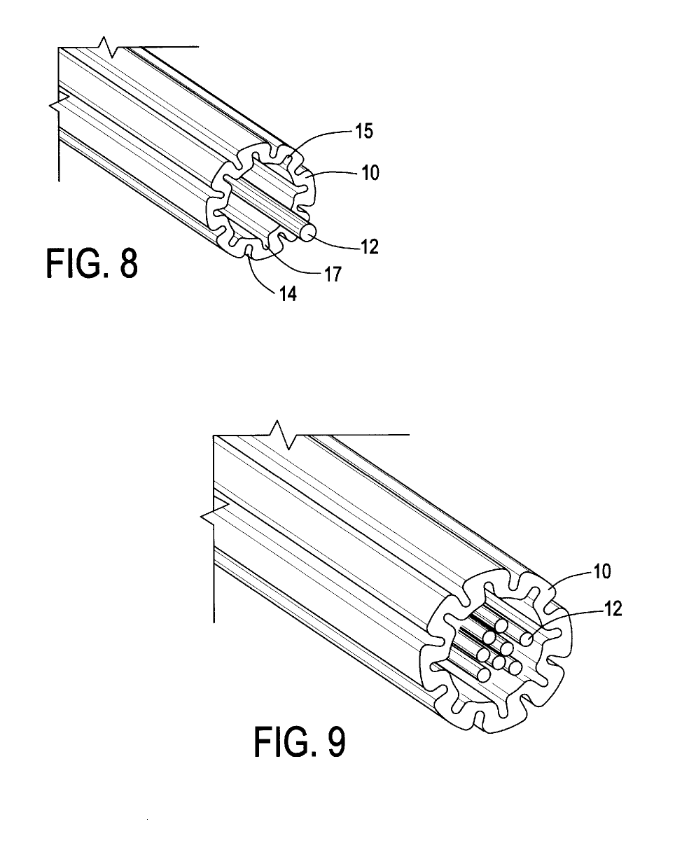

In another embodiment shown in FIGS. 8 and 9, a loose tube fiber cable arrangement is shown having buffer 10 surrounding one or more fibers 12 (FIG. 3 shows one (1) fiber 12 and FIG. 4 shows multiple fibers 12). As described above “loose tube” generally refers to the arrangement where there is measurable space (loose space) between the OD of fiber 12 and the ID of the buffer 12. In the arrangement shown in FIG. 8 buffer 10 has a plurality of outer grooves 14 located around the outer periphery of buffer 10, dividing buffer 10 into corresponding lobes 15. As with FIG. 1, buffer 10 in FIG. 8 likewise maintains a plurality of grooves 17 facing inward towards fiber 12. In FIG. 9, buffer 10 has multiple fibers 12 within a single buffer tube 10.

In the examples shown, FIG. 8 illustrates a loose tube fiber cable where buffer 10 exhibits an internal diameter (ID) of approximately 1 mm (measured at the main inner surface exempting grooves 17) and an outer diameter (OD) of approximately 1.6 mm (measured at the main outer surface exempting grooves 14). FIG. 4 illustrates a larger multi-fiber loose tube fiber cable where buffer 10 exhibits an internal diameter of approximately 2 mm and an outer diameter of approximately 3 mm.

In the arrangements shown in FIGS. 8 and 9 the loose buffer tubes 12 benefit from having grooves on the interior and exterior surface. Grooves 17 on the interior surface allow space for water swellable powder to reside and avoid direct (possibly attenuating) contact with fiber(s) 12. Inner grooves 17 additionally increase the slip between fiber(s) 12 and the interior of the tube 12 providing for improved attenuation. Exterior grooves 14 of tube 12 provide at least the same benefits as grooves 12 described above in the tight buffer examples in FIGS. 1-4 and 7.

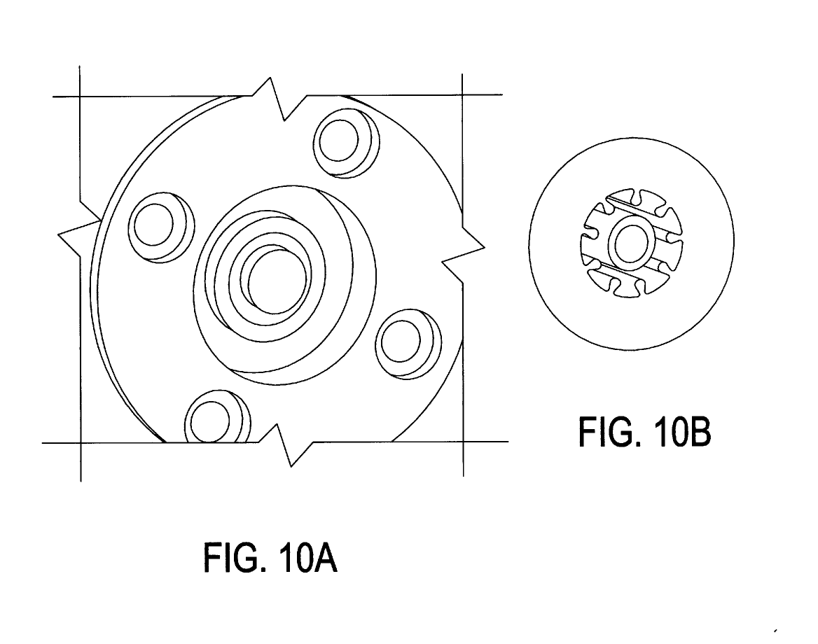

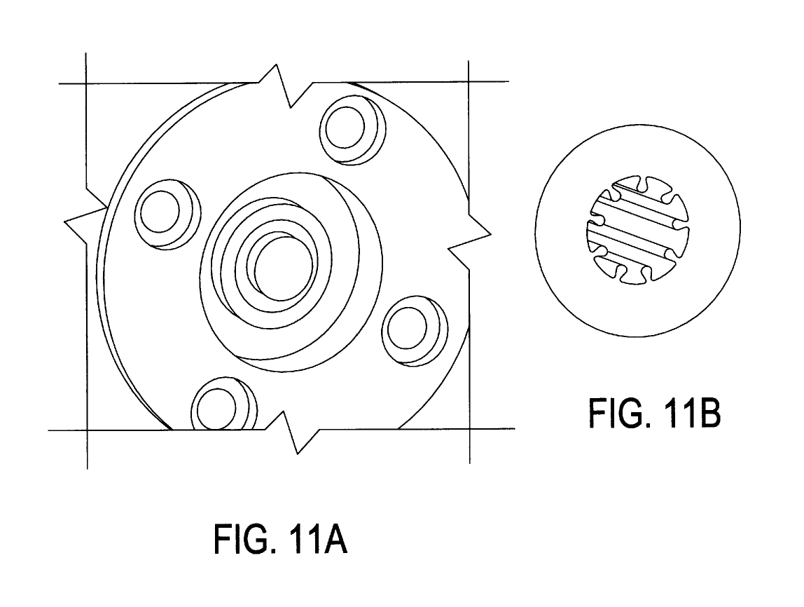

Turning to the construction of grooved buffers 10 and/or jackets 16, grooves 14, 17, 18 and 19 may be formed using either one of draw down/tubing processing or pressure extrusion. For example, FIGS. 10a and 10b (close up) show an exemplary die used for tube extrusion to produce a buffer 10 such as that having a shape as shown as the central buffer 10 in FIG. 7a. FIGS. 11a and 11b (close up) shows an exemplary die used for pressure extrusion to produce a buffer 10 again having a shape as shown as the central buffer 10 in FIG. 7a. Pressure type extrusion is used for buffer 12 when the engineer desires a product tight around the interior item (i.e. fiber 10). Tube/draw down extrusion is typically used when you want little or no pressure on the internal fiber 10.

Applicants note that pressure extrusion using the die for example shown in FIGS. 11a and 11b may be used when a consistent, precise diameter is required. However, pressure extrusion typically has a 1:1 draw down ratio with the tooling. As a result the tooling will be a similar size as the product size making the tooling difficult to manufacture. In these cases, the tooling is made by high precision electrode discharge machine process and the small sizes limit the amount of detail which can be design into the tools. As a result pressure extrusion may leave rounded corners when the grooves intersect with the outer diameter. On the other hand, tubing extrusion using an exemplary die from FIGS. 10a and 10b can have from a 1+:1 draw down ratio up to and above 150+:1, so the tools are much larger and more detail can be designed into the final insulation shape. Tubing processes allow greater detail such as sharp corners where the groove meets the outer diameter of the insulation, which may be useful in preventing nesting between adjacent fibers in some cases. However, the tubing process is generally less consistent and less accurate than pressure extrusion. The present arrangement of grooved fiber insulation for both loose tube and tight buffered fibers contemplates using either one of pressure extrusion and draw down extrusion depending on the specific requirements of the cable producer.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. An optical fiber cable, said cable comprising:
at least one optical fiber element; and
a tight buffer coating on said optical fiber element,
wherein said tight buffer coating on said optical fiber element includes a plurality of alternating splines and grooves facing outwardly towards the outer circumference of said tight buffer coating.

2. The optical fiber cable as claimed in claim 1, wherein said tight buffer coating includes between six and ten grooves and corresponding splines.

3. The optical fiber cable as claimed in claim 1, wherein said grooves on said tight buffer coating are substantially between 0.003″ and 0.008″ in size measured from the outer circumference of said tight buffer coating.

4. The optical fiber cable as claimed in claim 1, wherein said grooves on said tight buffer coating are substantially between 0.003″ and 0.006″ in width measured at said outer circumference of said tight buffer coating.

5. The optical fiber cable as claimed in claim 1, wherein the reduction in weight associated with said grooves is substantially in the 10%-20% relative to a standard 0.0354″ (900 micron) diameter tight buffer coating.

6. The optical fiber cable as claimed in claim 1, wherein said splines between said grooves on said outer surface of said tight buffer coating are dimensioned and sized to deflect under compression to deflect crushing pressure away from said optical fiber element.

7. The optical fiber cable as claimed in claim 1, wherein said tight buffer coating includes a plurality of alternating splines and grooves facing inwardly towards said optical fiber element.

8. The optical fiber cable as claimed in claim 1, wherein said optical fiber cable further includes a jacket surrounding said tight buffer coating.

9. The optical fiber cable as claimed in claim 8, wherein said jacket surrounding said tight buffer coating further includes either one of alternating outwardly facing splines and grooves or inwardly facing splines and grooves.

10. An optical fiber cable, said cable comprising:
at least one optical fiber element; and
a tight buffer coating on said optical fiber element,
wherein said tight buffer coating on said optical fiber element includes a plurality of alternating splines and grooves facing inwardly towards said optical fiber.

11. The optical fiber cable, as claimed in claim 10, further comprising a water swellable powder on said fiber optic element.

12. An optical fiber cable, said cable comprising:
at least one optical fiber element; and
at least one buffer tube surrounding said optical fiber element,
wherein said buffer tube around said optical fiber element includes a plurality of alternating splines and grooves facing outwardly towards the outer circumference of said buffer tube.

13. The optical fiber cable as claimed in claim 12, further comprising a plurality of optical fiber elements within said buffer tube.

14. The optical fiber cable as claimed in claim 12, wherein said buffer tube around said optical fiber element further includes a plurality of alternating splines and grooves facing inwardly towards said optical fiber element.

15. The optical fiber cable as claimed in claim 12, wherein said optical fiber cable further includes a jacket surrounding said buffer tube.

16. The optical fiber cable as claimed in claim 15, wherein said jacket surrounding said buffer tube further includes either one of alternating outwardly facing splines and grooves or inwardly facing splines and grooves.
